(19) United States
(12) Patent Application Publication
(10) Pub. No.: US 2002/0156655 A1
(43) Pub. Date: Oct. 24, 2002

(54) Guaranty system

(76) Inventors: Yutaka Matsuda, Tokyo (JP); Akihiko Hongyo, Kanagawa (JP); Koji Shiraishi, Kanagawa (JP)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 09/838,427

(22) Filed: Apr. 19, 2001

(51) Int. Cl. G06F 17/60

(52) U.S. Cl. 705/4

(57) ABSTRACT

In a guaranty system according to the present invention, a guarantee obtains from a guarantor a guaranty which guarantees that an amount of an industrial emission generated from a preset industrial business fulfills a preset requirement. Along with the guaranty, the guarantor provides an industrial hardware required to carry out the industrial business to the guarantee without any charge for the hardware. The guarantee may obtain the guaranty through a transaction of purchase and sale of the guaranty, or of a lease of the guaranty. The industrial emission is at least one selected from a waste gas, a waste liquid, an odor, a vibration, a noise, a light, and a ray. The preset requirement is defined by an Official Requirement against the industrial emission.

### BACKGROUND OF THE INVENTION

1. Field of the Invention

The present invention relates to a guaranty system.

2. Description of the Related Art

In general, a user or manufacturer who wishes to start an industrial business or act obtains an industrial hardware such as a plant. Typically, such a hardware is associated with a guaranty. Specifically, it is guaranteed that amounts of industrial emissions, such as wasted gases and wasted liquids, generated from the hardware, fulfill Official Requirements against the industrial emissions.

However, the guaranty is directed only to an initial performance of the hardware. In other words, it is not guaranteed that the emission amounts fulfill the Official Requirements for a long period of time.

As a result, the user must assure by himself that the emission amount of the hardware fulfill the Requirements. Otherwise, the user must make a contract to maintain the emission amount fulfilling the Requirements, apart from the contract for obtaining the hardware.

Accordingly, a problem may arise that the conventional guaranty system requires much costs to fulfill requirements against the industrial emissions.

### SUMMARY OF THE INVENTION

An object of the invention is to provide a new guaranty system which is capable of reducing the costs required for an industrial hardware to fulfill requirements against industrial emissions.

According to one aspect of the present invention, there is provided a guaranty system, wherein a guaranty provider provides a guaranty which guarantees that an amount of an industrial emission generated from a preset industrial business fulfills a preset requirement, wherein a guarantee obtains the guaranty from the provider, and wherein a guarantor provides the guarantee with a hardware required to carry out the industrial business to a guarantee without any charge for the hardware.

According to another aspect of the present invention, there is provided a transaction of a guaranty which guarantees that an amount of an industrial emission generated from a preset industrial business fulfills a preset requirement against industrial emissions.

The present invention may be more fully understood from the description of the preferred embodiments of the invention as set forth below, together with the accompanying drawings.

### BRIEF DESCRIPTION OF THE DRAWINGS

In the drawings:

FIGS. 1 and 2 respectively illustrate schematic diagrams for explaining a guaranty system according to embodiments of the present invention, where a guarantee obtains a guaranty through a transaction of purchase and sale; and

FIGS. 3 and 4 respectively illustrate schematic diagrams for explaining a guaranty system according to embodiments of the present invention, where a guarantee obtains a guaranty through a transaction of lease.

### DESCRIPTION OF THE PREFERRED EMBODIMENTS

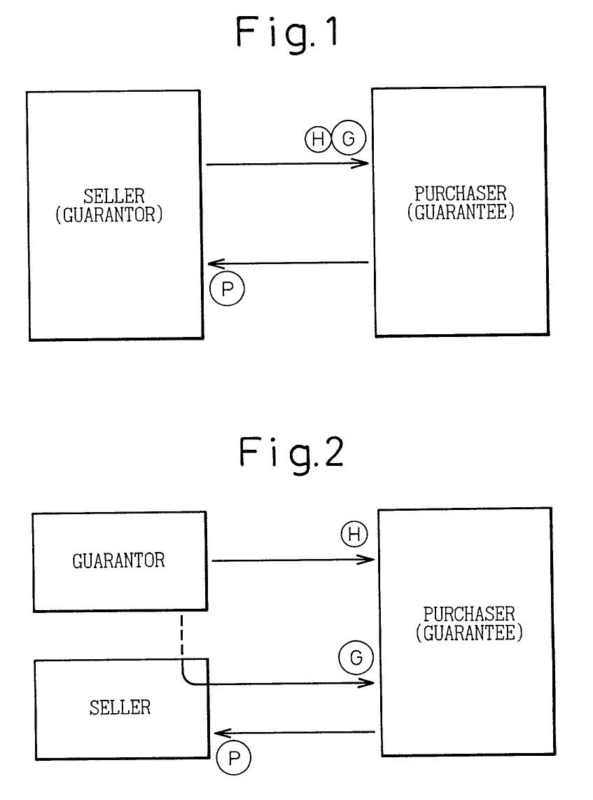

FIG. 1 shows an embodiment of a guaranty system according to the present invention, where a guarantee obtains a guaranty through a transaction of purchase and sale.

Referring to FIG. 1, a purchaser or user, who wishes to start an industrial business or act, purchases a guaranty G from a seller, and makes a payment P for the purchase of the guaranty G to the seller.

The guaranty G is one that guarantees that an amount of an industrial emission generated from the industrial business fulfills a preset requirement for a preset period of time.

The industrial business may be any business, as long as it entails the industrial emission. The industrial emission may be at least one selected from a waste gas, a waste liquid, an odor, a vibration, a noise, a light, and a ray.

In this embodiment, the preset requirement is an Official Requirement including law, rule, and regulation, against the industrial emissions, which is established by Federal or State Government or Agent. Alternatively, it may be any requirement.

Along with the guaranty G, the seller provides to the purchaser an industrial hardware H which is required to carry out the industrial business, without any extra charge.

The hardware H may be at least one selected from a plant, a machinery, an apparatus, and an equipment, for carrying out the industrial business. Alternatively, the hardware H may be one for a preparation of the industrial business, such as for a construction of the plant.

Therefore, for example, it is guaranteed that an amount of a certain component contained in the wasted gas from the hardware H is smaller than a respective upper limit, or an amount of another component is larger than a respective lower limit, the upper and lower limit being defined by the Official Requirement.

Specifically, the seller who is a guarantor in this embodiment takes necessary actions to maintain the emission amount of the hardware to fulfill the Official Requirement for the guaranty period of time. More specifically, the seller repairs or replaces a whole or part of the hardware. Note that the purchaser is a guarantee in this embodiment.

The seller can provide any type of hardware, as long as the emission amount thereof fulfills the Official Requirement. In other words, there is no need for the seller to prepare a new hardware. As a result, costs required for the seller to prepare the hardware is reduced, and therefore the purchase price of the hardware is also reduced.

The guaranty period of time may be set to any period, depending on the user's demand. Therefore, the emission amount can be guaranteed to fulfill the Official Requirement for a long period of time. Even a permanent guaranty is selectable.

The purchase price of the guaranty depends on the guaranty period of time, or on the industrial business to be guaranteed. The purchaser can select from various ways to make a payment for the guaranty, including a divided payment or a lump-sum payment.

In the conventional purchase and sale, the transaction is directed to the hardware, rather than the guaranty. This means that the ownership of the hardware is transferred to the purchaser, and the purchaser must take risks derived from the ownership.

Contrarily, in this embodiment, the transaction is directed to the guaranty, rather than the hardware. Therefore, an ownership of the hardware is not transferred to the purchaser. As a result, the purchaser can avoid various risks derived from the ownership.

Optionally, the transaction may include an additional contract in which the seller conducts maintenance of the hardware. Specifically, even when the emission amount fulfills the Official Requirement, a performance of the hardware such as an efficiency or an output thereof, may deteriorate. Therefore, the purchaser can commission the necessary maintenance of the hardware to the seller, apart from the purchase of the guaranty.

The transaction may also include another contract in which the seller conducts operation of the hardware.

Of course, the purchaser can conduct the maintenance or the operation of the hardware.

In the embodiment shown in FIG. 1, a seller and a guarantor are the same. Alternatively, a seller and a guarantor may be different from each other.

Specifically, as shown in FIG. 2, the seller has purchased the guaranty G from the guarantor, in advance. Then, the seller resells the guaranty G to the purchaser or the guarantee. In this case, the guarantor may provide the hardware H to the guarantee directly.

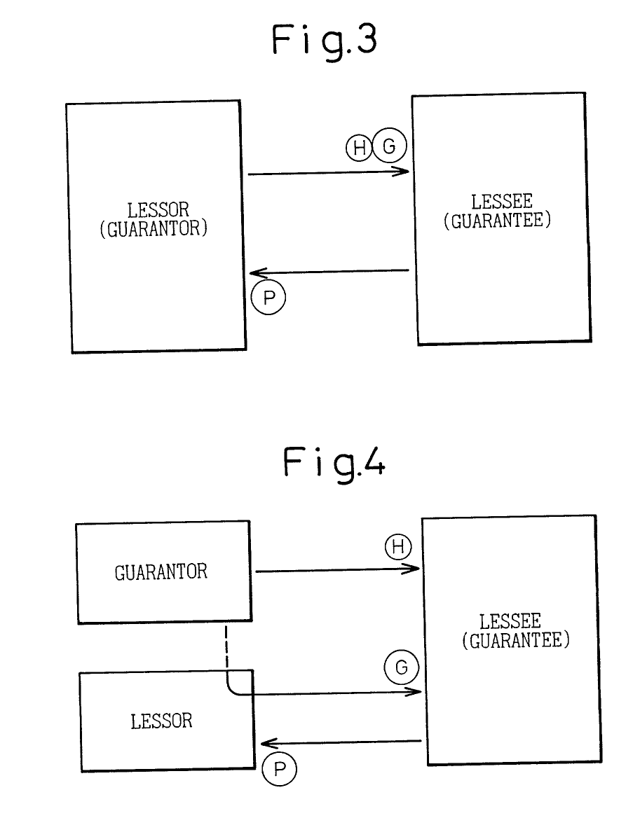

FIG. 3 shows another embodiment of a guaranty system according to the present invention, where a guarantee obtains a guaranty through a transaction of lease.

Referring to FIG. 3, a lessee or user, who wishes to start an industrial business or act, leases or rents a guaranty G from a lessor, and makes a payment P for the lease of the guaranty G to the lessor.

Along with the guaranty G, the lessor provides to the lessee an industrial hardware H which is required to carry out the industrial business, without any extra charge.

In this embodiment, the lessor who is a guarantor maintains the emission amount of the hardware to fulfill the Official Requirement for the guaranty period of time. Note that the lessee is a guarantee in this embodiment.

The lessor can provide any type of hardware, as long as the emission amount thereof fulfills the Official Requirement, as in the above-mentioned embodiment. As a result, costs required for the lessor to prepare the hardware is reduced, and therefore the lease fee of the hardware is also reduced.

Further, the ownership of the hardware is not transferred to the lessee, and thus the lessee can avoid risks derived therefrom.

As in the case shown in FIG. 2, a lessor and a guarantor may be different from each other. Specifically, as shown in FIG. 4, the lessor has obtained, i.e., has purchased or leased, the guaranty G from the guarantor, in advance. Then, the lessor leases the guaranty G to the lessee or the guarantee.

Other details of this guaranty system are substantially the same as those of the guaranty system where the transaction is purchase and sale, and therefore they are omitted.

According to the present invention, it is possible to provide a new guaranty system which is capable of reducing the costs required for an industrial hardware to fulfill requirements against industrial emissions.

While the invention has been described by reference to specific embodiments chosen for purposes of illustration, it should be apparent that numerous modifications could be made thereto by those skilled in the art without departing from the basic concept and scope of the invention.

1. A guaranty system,
wherein a guaranty provider provides a guaranty which guarantees that an amount of an industrial emission generated from a preset industrial business fulfills a preset requirement,
wherein a guarantee obtains the guaranty from the provider, and
wherein a guarantor provides the guarantee with a hardware required to carry out the industrial business to a guarantee without any charge for the hardware.

2. A guaranty system according to claim 1, wherein the hardware is at least one selected from a plant, a machinery, an apparatus, and an equipment, which are required to carry out the industrial business.

3. A guaranty system according to claim 1, wherein the guarantor conducts maintenance of the hardware.

4. A guaranty system according to claim 1, wherein the guarantor conducts operation of the hardware.

5. A guaranty system according to claim 1, wherein the guarantee obtains the guaranty from the provider through a transaction of purchase and sale of the guaranty.

6. A guaranty system according to claim 1, wherein the guarantee obtains the guaranty from the provider through a transaction of a lease of the guaranty.

7. A guaranty system according to claim 1, wherein the industrial emission is at least one selected from a waste gas, a waste liquid, an odor, a vibration, a noise, a light, and a ray.

8. A guaranty system according to claim 1, wherein the preset requirement is defined by an Official Requirement against the industrial emission.

9. A guaranty system according to claim 1, wherein the provider and the guarantor are identical to each other.

10. A guaranty system according to claim 1, wherein the provider and the guarantor are different from each other.

11. A transaction of a guaranty which guarantees that an amount of an industrial emission generated from a preset industrial business fulfills a preset requirement.

12. A transaction according to claim 11, wherein a guarantor provides, along with the guaranty, an industrial hardware required to carry out the industrial business to a guarantee without any charge for the hardware.

13. A transaction according to claim 12, wherein the hardware is at least one selected from a plant, a machinery, an apparatus, and an equipment, which are required to carry out the industrial business.

14. A transaction according to claim 12, including a contract in which the guarantor conducts maintenance of the hardware.

15. A transaction according to claim 12, including a contract in which the guarantor conducts operation of the hardware.

16. A transaction according to claim 11, wherein the transaction is purchase and sale of the guaranty.

17. A transaction according to claim 11, wherein the transaction is a lease of the guaranty.

18. A transaction according to claim 11, wherein the industrial emission is at least one selected from a waste gas, a waste liquid, an odor, a vibration, a noise, a light, and a ray.

19. A transaction according to claim 11, wherein the preset requirement is defined by an Official Requirement against the industrial emission.
